(19) United States
(12) Patent Application Publication
(10) Pub. No.: US 2008/0049282 A1
(43) Pub. Date: Feb. 28, 2008

(54) Color separated display imaging system

(76) Inventor: Gaylord E. Moss, Marina del Rey, CA (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/893,303

(22) Filed: Aug. 14, 2007

Related U.S. Application Data
(60) Provisional application No. 60/837,550, filed on Aug. 14, 2006.

(51) Int. Cl. G03H 1/28; G02B 27/22; G03H 1/06

(52) U.S. Cl. 359/23; 359/22; 359/28; 359/462

(57) ABSTRACT

A system is disclosed for recording a diffraction optical element providing a stereographic image to an observer includes a monochromatic light source having a characteristic wavelength providing a single source beam and a recording plate made from a material sensitive substantially to the characteristic wavelength. The system also includes at least first, second and third diffusers each having a characteristic wavelength differing from one another, a first beam split from the single source beam received from the monochromatic light source at the wavelength and at least one mirror reflecting a second split beam as a converging reference beam from the light source. The recording plate is exposed to the diffuse light beam separately passing through the first, second and third diffusers and received from the first beam and is exposed to the converging reference beam to form thereby the diffraction optical element.

### CROSS REFERENCE TO RELATED APPLICATIONS

This application claims priority to U.S. Provisional Patent Application Ser. No. 60/837,550 by Gaylord E. Moss, filed on Aug. 14, 2006, entitled “COLOR SEPARATED DISPLAY IMAGING SYSTEM,” the entire contents of which is incorporated by reference herein.

### BACKGROUND

1. Technical Field

The present disclosure is directed to an optical display that uses diffraction optical elements to produce a full color stereographic image for single or multiple observers. More particularly, the present disclosure is directed to an optical display that uses a diffraction optical element to separate images from a pair of projectors and to direct these stereo images to the appropriate eye of the observer.

2. Description of the Related Art

The various methods that have been developed to give a different image to each eye for stereo viewing can be divided into those that use viewing aids such as polarized glasses or those that leave the viewer unencumbered. This second method is termed auto-stereo. The first class of systems that use viewing aids, although they do provide stereoscopic views, are not favored for continuous use because the added viewing attachments may generate fatigue and discomfort in the wearers. This class includes: polarized glasses, colored glasses and time-sharing shutter glasses. Aside from the basic discomfort of the attachments, there are other disadvantages. Polarized glasses throw away more than half the light in the display as well as distort the color. Colored glasses severely degrade the color rendition and the switching of the view from one eye to the other may cause traumatic medical reactions in some users.

Looking at the class of viewers without needed attachments, there are many current auto-stereo systems but all of these have other disadvantages. One of the earliest of these uses lenticular lenses that restrict each eye to see strips of two different scenes. Recently, many other variations have been developed such as the use of solid barriers or illumination strips arranged to separate the two views. All these space-sharing techniques degrade resolution by at least a factor of two. Further, there is only a limited viewing area in which the correct stereo image is seen. Moving out of that area causes the image to double or even invert its spatial character.

Another approach to making a three-dimensional image is to create the full wave-fronts for the actual object in space. Several large laboratories have had long-term programs to make real-time holograms to create such images. A working system is still many years away.

Other approaches relate to the scanning of light beams onto spinning screens—a technology dating back to the 1950's with the exception that electron tubes are now replaced with laser scanners. This approach tends to produce fuzzy images with very poor resolution.

Still another approach is to generate real 3-D objects with layered screens at different depths, e.g., with liquid crystal screens. The need to blend the different layers also tends to produce fuzzy images.

Another way to make a diffraction optical element which plays back in full color is to record the light from a long strip diffuser which is oriented at such an angle that there is a region in which all colors are seen. Newswanger, in U.S. Pat. No. 4,799,739, discloses this approach to making a full color display.

### SUMMARY

To advance the state of the art with respect to systems for recording diffraction optical elements, the present disclosure relates to a system for recording a diffraction optical element providing a stereographic image to an observer. The system includes a monochromatic light source having a characteristic wavelength wherein the light source is configured to provide a single source beam at the wavelength characteristic of the light source. The system includes a recording plate made from a material sensitive substantially only to the characteristic wavelength of the source beam emitted by the monochromatic light source, at least first, second and third diffusers each having a characteristic wavelength differing from one another. The at least first, second and third diffusers are configured and disposed to output as a diffuse light beam separately first, second and third diffraction patterns, respectively, a first beam split from the single source beam received from the monochromatic light source. The first beam is at the wavelength characteristic of the monochromatic light source. The system includes at least one mirror configured and disposed to reflect as a converging reference beam a second beam split from the single beam received from the monochromatic light source. The second beam is at the wavelength characteristic of the monochromatic light source. The recording plate is exposed to the diffuse light beam separately passing through the at least first, second and third diffusers and received from the first beam and, and the recording plate is exposed to the converging reference beam reflected from the at least one mirror to form thereby the diffraction optical element.

In one embodiment, the recording plate is exposed to the diffuse light beam output from the at least first, second and third diffuser screens sequentially. In one embodiment, the recording plate is exposed to the diffuse light beam output from the at least first, second and third diffuser screens concurrently.

The at least first, second and third diffuser screens may be each characterized by an image, wherein when the respective images are reconstructed from the diffraction optical element, the reconstructed images substantially overlay one another. In one embodiment, the first optical diffuser is disposed at a first distance from the recording plate, the second optical diffuser is disposed at a second distance from the recording plate, and the third optical diffuser is disposed at a third distance from the recording plate. The first distance may be greater than the second distance and the second distance may be greater than the third distance.

The present disclosure relates also to a system for viewing a diffraction optical element providing a stereographic image to an observer. The system includes a diffraction optical element wherein the diffraction optical element is made by a monochromatic light source having a characteristic wavelength. The light source is configured to provide a single source beam at the wavelength characteristic of the light source. The diffraction optical element may be made from a recording plate made from a material sensitive substantially only to the characteristic wavelength of the source beam emitted by the monochromatic light source. The diffraction optical element is made by at least first, second and third diffusers each having a characteristic wavelength differing from one another. The at least first, second and third diffusers are configured and disposed to output as a diffuse light beam separately as first, second and third diffraction patterns, respectively, a first beam split from the single source beam received from the monochromatic light source. The first beam is at the wavelength characteristic of the monochromatic light source. The diffraction optical element is made by at least one mirror configured and disposed to reflect as a converging reference beam a second beam split from the single beam received from the monochromatic light source. The second beam is at the wavelength characteristic of the monochromatic light source. The recording plate is made by exposure to the diffuse light beam separately passing through the at least first, second and third diffusers and received from the first beam, and is made by exposure to the converging reference beam reflected from the at least one mirror. The diffraction optical element is a recorded interference pattern between the converging reference beam and the diffuse light beam output from the at least one diffuser to form thereby the diffraction optical element. In one embodiment, the diffraction optical element is disposed between at least first and second optical projectors and an observer. The observer and the diffraction optical element form generally a forward field of view, and the at least first and second optical projectors each projects a light beam onto the diffraction optical element from an angle below the forward field of view.

The present disclosure relates also to a system for recording a diffraction optical element providing a stereographic image to an observer that includes first, second, and third monochromatic light sources each emitting a coherent monochromatic light beam having a wavelength and a recording plate. The system includes at least one diffuser configured and disposed to output a diffuse light beam from the at least first, second and third monochromatic light sources, and at least one concave mirror configured and disposed to reflect a converging reference beam from the at least first, second and third monochromatic light sources, wherein the recording plate is exposed to the diffuse light beam output from the at least one diffuser, and wherein the recording plate is exposed to the converging reference beam reflected from the at least one concave mirror. In one embodiment, the wavelength of the coherent monochromatic light beam emitted from the first monochromatic light source differs from the wavelength of the coherent monochromatic light beam emitted from the second monochromatic light source and from the wavelength of the coherent monochromatic light beam emitted from the third monochromatic light source, and the wavelength of the coherent monochromatic light beam emitted from the second monochromatic light source differs from the wavelength of the coherent monochromatic light beam emitted from the third monochromatic light source. The system may include a first dichroic beam splitter configured and disposed to receive the coherent monochromatic light beam emitted from the first monochromatic light source, a second dichroic beam splitter configured and disposed to receive the coherent monochromatic light beam emitted from the second monochromatic light source, and a third dichroic beam splitter configured and disposed to receive the coherent monochromatic light beam emitted from the third monochromatic light source. In one embodiment, the system includes a fourth dichroic beam splitter, wherein the first, second and third dichroic beam splitters are each configured and disposed to allow the coherent monochromatic light beam emitted from the first monochromatic light source and received by the first dichroic beam splitter, the coherent monochromatic light beam emitted from the second monochromatic light source and received by the second dichroic beam splitter, and the coherent monochromatic light beam emitted from the third monochromatic light source and received by the third dichroic beam splitter to be each aligned coaxially as a coherent chromatic or multichromatic light beam. The fourth dichroic beam splitter is disposed with respect to the first, second and third dichroic beam splitters to split the respective coaxially aligned coherent multichromatic light beams split by the first, second and third dichroic beam splitters into at least first and second multichromatic light beams, wherein the first multichromatic light beam is the diffuse light beam output from the at least one diffuser, and wherein the second multichromatic light beam is the converging reference beam reflected from the at least one concave mirror. In one embodiment, the system includes a first shutter disposed between the first monochromatic light source and the first dichroic beam splitter to selectively enable transmission and termination of the first monochromatic light beam from the first monochromatic light source, a second shutter disposed between the second monochromatic light source and the second dichroic beam splitter to selectively enable transmission and termination of the second monochromatic light beam from the second monochromatic light source, and a third shutter disposed between the third monochromatic light source and the third dichroic beam splitter to selectively enable transmission and termination of the third monochromatic light beam from the third monochromatic light source. The first, second and third shutters are individually operated to selectively transmit and terminate the respective first, second and third monochromatic light beams to enable exposure of the recording plate.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is an illustration of a diffraction optics auto-stereo viewing screen in a playback or reconstruction mode according to the present disclosure;

FIG. 2 is an illustration of a construction beam layout for recording a monochromatic diffraction optics element according to the present disclosure;

FIGS. 3A and 3B are a side view and a top view, respectively, of an illustration of a single projector diffracting a single image to a viewing pupil;

FIGS. 4A and 4B is a side view and a top view, respectively, of an illustration of a pair of offset projectors diffracting different images to left and right viewing pupils according to the present disclosure;

FIG. 5 is perspective view of a single strip diffuser plate according to the prior art;

FIG. 6 is a schematic block diagram of a construction beam layout for a diffraction optical element made having at least three exposure wavelengths according to the present disclosure;

FIG. 7 is an illustration of three viewing pupil sizes and locations during construction of a diffraction optical element suitable for playback at three different wavelengths according to the present disclosure;

FIG. 8 shows a system for recording or producing the recording plate of FIG. 7 with multiple diffusers illuminating the recording plate concurrently according to the present disclosure;

FIG. 9 shows a system for recording or producing the recording plate of FIG. 7 with multiple diffusers illuminating the recording plate sequentially according to the present disclosure;

FIG. 10 shows the nomenclature defining the terms used in calculating the position of diffusers in the recording system;

FIG. 11 shows the numerical values used in the calculations for an example system;

FIG. 12 illustrates a spreadsheet showing the calculations for the ray directions defining the center points for diffusers required in the recording system to record diffusion pupils for four different wavelengths;

FIG. 13 illustrates a spreadsheet showing the calculations for the ray directions defining the top edges for diffusers required in the recording system to record diffusion pupils for four different wavelengths;

FIG. 14 illustrates a spreadsheet showing the calculations for the ray directions defining the bottom edges for diffusers required in the recording system to record diffusion pupils for four different wavelengths;

FIG. 15A is a diagram showing the edge and center rays from the recording plate to the center of the green diffusion plate used in recording the green wavelength viewing pupil in an example system defined by the look-down angle of 5 degrees and viewing pupil distance of 40 inches shown in FIG. 15A;

FIG. 15B is a diagram showing the center rays defining the centers of the required diffusion plates 36a′, 36b′ and 36c′. These ray directions are taken from the calculations shown in the spreadsheet of FIG. 12; and

FIG. 15C is a diagram showing the ray directions which define the tops and bottoms of the three diffusers calculated from the spreadsheets of FIGS. 13 and 14. These top and bottom positions define the edges of the three diffusers, 36a, 36b and 36c.

### DETAILED DESCRIPTION

Embodiments of the presently disclosed system and method are described herein below with reference to the accompanying drawing figures wherein like reference numerals identify similar or identical elements. In the following description, well-known functions or constructions are not described in detail to avoid obscuring the disclosure in unnecessary detail.

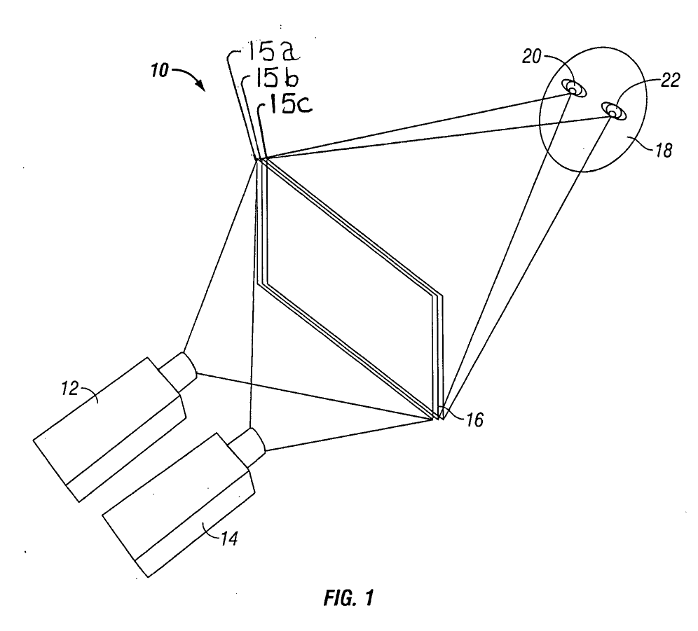

The display of the current disclosure is of the auto-stereo type and thus has the advantage that the observer does not need to wear any added equipment to view stereo images. A further advantage is that the image seen by each eye occupies the whole area of the screen and thus does not suffer from the area resolution loss of prior lenticular autostereoscopic displays which dedicate alternate sections of the display to the left and right images. In the subject display, a diffraction optical element screen is used to separate two projected images so that one is directed to either eye. The angles at which the two projectors address the diffraction optical element determine which eye receives each projection image. FIG. 1 shows the basic operation of this display 10.

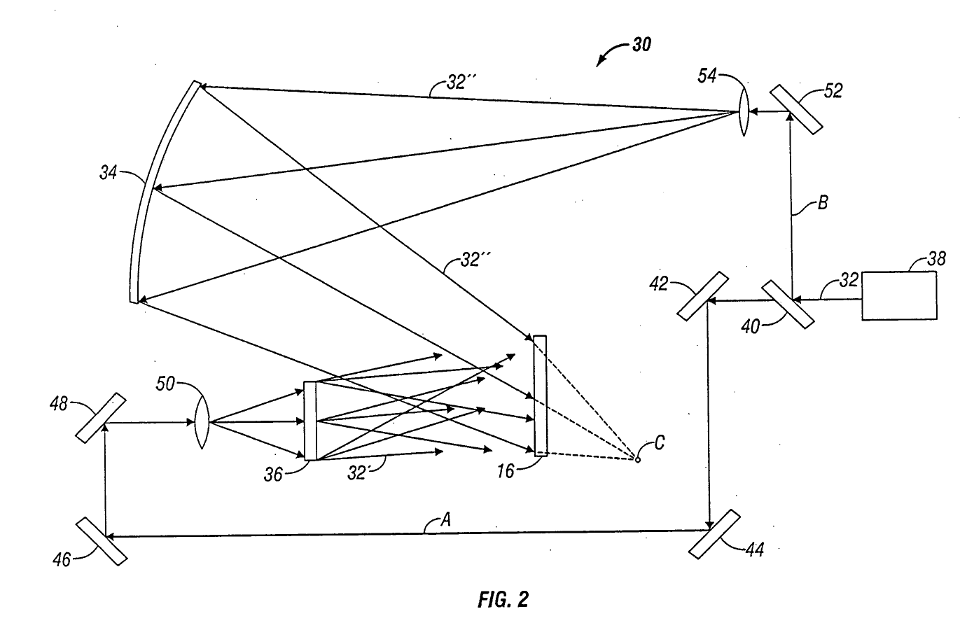

The display 10 includes a projector pair 12, 14 and a diffraction optical element 16. The diffraction optics element 16′ separates two projected images so that one is directed to either eye of the observer 18. The angles at which the two projectors 12, 14 address the diffraction optical element 16′ determines which eye 20, 22 receives each projection image. As shown, the left projector 12 transmits an image through the diffraction optical element 16′ to the observer's left eye 22, and the right projector 14 transmits an image to the observer's right eye 20. The diffraction optical element 16′ may be formed by exposure of a single recording plate 16 to multiple monochromatic light beams as explained below with respect to FIG. 2 or exposing separately multiple holographic plates, e.g., holographic plates 15a, 15b 15c, at different times using the same wavelength for each holographic plate.

FIG. 2 illustrates the optical layout 30 of an exposure configuration. More particularly, FIG. 2 shows the optical layout 30 needed to record the transmission diffraction optical element 16 shown in FIG. 1 that provides the optical function to separate the two images on the diffraction optical element 16′ and direct each to the appropriate eye 20, 22 as shown in FIG. 1. These wave fronts must be phase locked during the recording so that the interference pattern is stable during the recording. As shown in FIG. 2, the diffraction optical element 16′ is a holographic recording of a converging reference beam 32″ from the concave mirror 34 and the diffuse beam 32′ from a diffusion plate 36 which is located in what will become, in playback, the observer's pupil plane. The mutual coherence of the two beams 32′, 32″ is achieved since both beams 32′, 32″ are generated from the same output or source beam from monochromatic light source or laser 38 by a beam-splitter 40.

The system 30 includes beam splitter 40, reflectors 42, 44, 46, and 48 and a spatial filter 50. The source beam of coherent light 32 is split by the beam splitter 40 into an object beam “A” and a reference beam “B”. The object beam “A” is reflected by the first reflector 42, a second reflector 44, and a third reflector 46 and the fourth reflector 48 and then through a first spatial filter 50 to illuminate the diffuser plate 36.

The reference beam “B” is reflected off of the reflector 52 and travels through the second spatial filter 54 where it is expanded to form reference beam 32″ that is then reflected off of the concave mirror 34 to form a beam which converges to focus at point C. The recording plate 16 is then exposed simultaneously to this beam converging toward point C and to the diffuse light from the diffuser plate 36. The interference pattern between these two sources of light is recorded in plate 16 that, after processing of the recording material, becomes the finished diffraction element 16′ of FIG. 1. Chemical or other processing methods are well known for a variety of holographic recording materials that might be used in the recording plate 16 to make an efficient diffraction optical element 16′.

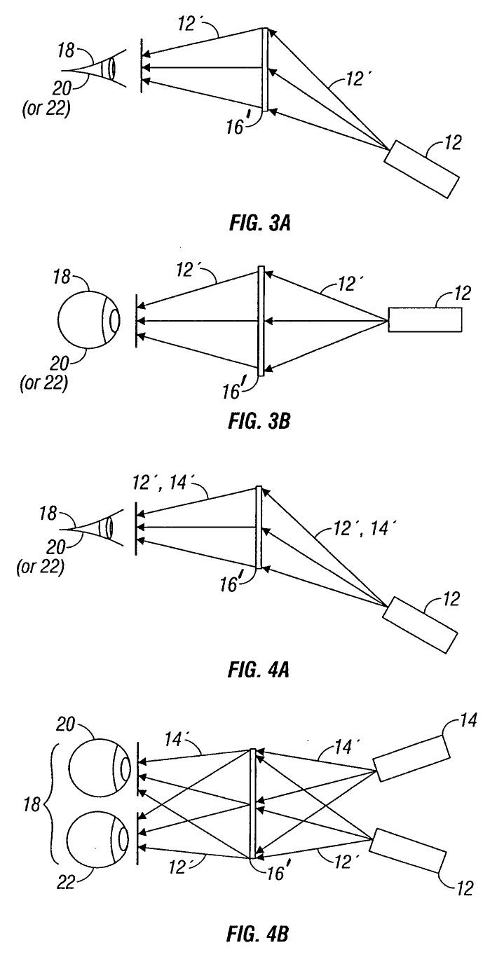

FIGS. 3A and 3B show how the diffraction optical element 16′ diffracts the image from a single projector to a single viewing area. The area is large enough so that one eye of an observer 18 when placed in the region of the diffracted rays can see the image from that projector. FIG. 3A shows the side view and FIG. 3B shows the top view.

FIGS. 4A and 4B show how the diffracted light from two angled projectors are diffracted by plate 16 to create two viewing areas, so that each eye sees the image from a different projector and thus the viewer sees a stereo image if each projector shows the different stereo views.

To make a single viewing area as shown in FIGS. 3A and 3B, projector 12 is placed at the focus point “C” for the construction reference beam 32″ of the system 10 of FIG. 2. The projector 12 focuses a flat, two-dimensional image on the diffraction optical element 16′ as shown in FIGS. 3A-3B. The diffraction optical element 16′ diffracts this focused image on the diffraction optical element 16′ so that the light from the diffraction optical element 16′ spreads out as diffuse light illuminating the position formerly occupied by the diffuser 36 in FIG. 2 during exposure. As shown in FIG. 3A, an eye 20 (or 22) of an observer 18 placed at this former diffuser plane during exposure of FIG. 2 will see the light from the focused image on the diffraction optical element 16′. The light from each illuminated point in the diffraction optical element 16′ image will be spread out evenly in the area or plane where the diffuser 36 was located during the diffraction optical element 16′ construction. With one projector 12, as shown, the observer 18 sees a single two-dimensional image.

FIGS. 4A-4B show how the diffraction optical element of FIGS. 3A-3B can create a stereo image by using two projectors 12, 14. Each projector 12, 14 focuses a different image on the diffraction optical element 16; one projector 14 projects the image as it would be seen by the right eye 22 and the other projector 12 as would be seen by the left eye 20. Since each projector 12, 14 is aimed at a slightly different angle, the diffracted images 3A and 3B are displaced to positions side by side. When the observer 18 places his or her head so that one eye 20 is in the image from one projector 12 and the other eye 22 is in the image from the other projector 14, as shown in (FIG. 4A), the observer 18 sees a stereo three-dimensional image.

Thus far, the system 10 has been described for a monochromatic image. For many purposes, it is necessary to have a full color image. This may be accomplished in several ways.

Long Strip Diffuser for Overlapping Pupils

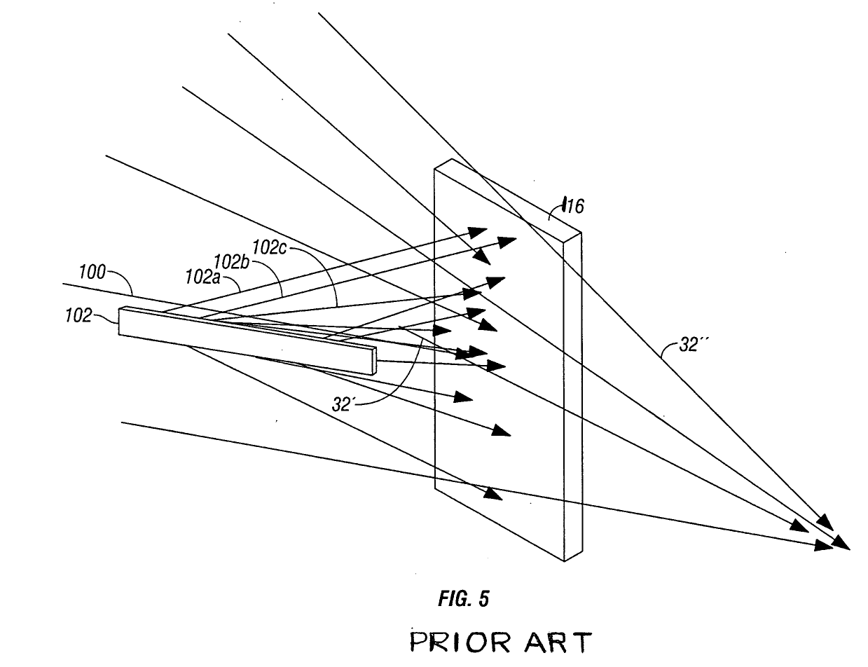

FIG. 5 shows a single strip diffuser plate of the prior art that enables a full color image by recording a recording plate 116 at a single wavelength and giving a resulting diffraction optical element resulting from the recording of recording plate 116 the capability of playing back images in full color by making a recording viewing pupil 100 as a long strip or single strip diffuser plate 102. The long strip 102 has sections 102a, 102b, 102c which form a diffraction grating that diffracts a particular wavelength into a common viewing pupil area. When one calculates points on such a strip 102, one finds that they fall in a nearly straight line. The diffuser plate 102 to record such a recording plate 116 is therefore a long straight strip 102 as shown in FIG. 5. Although this strip diffuser 102 makes it possible to see full color reconstructed views, there are disadvantages such as variation in color as the eye moves within the pupil and poor definition of the pupil edges due to the slant of the pupil in space and the distortion of the pupils as they are overlaid.

Multiple Wavelength Recording

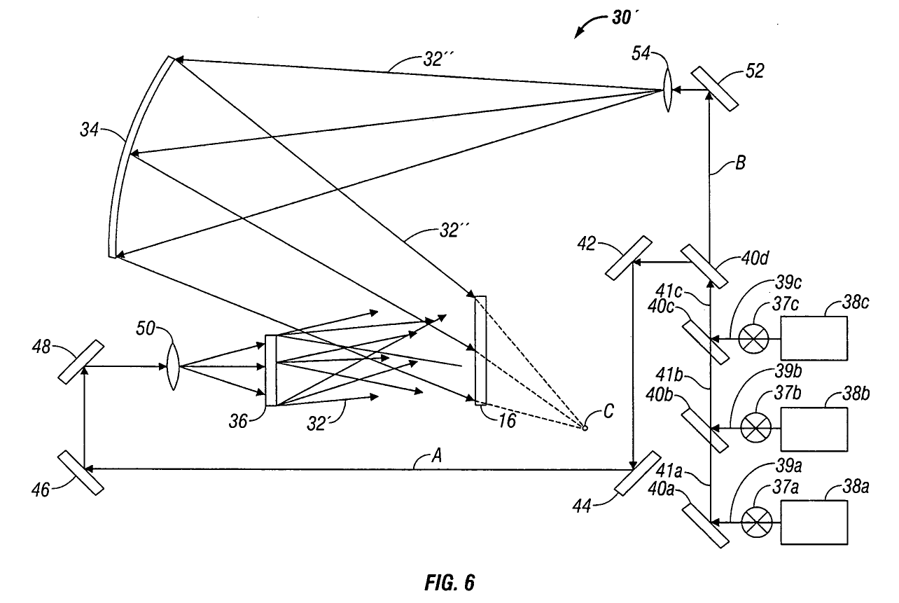

FIG. 6 shows a system 30′ with the same construction beam layout 30 as in FIG. 2 except the single monochromatic light source or laser 38 of FIG. 2 has been replaced with three monochromatic light sources or lasers 38a, 38b, 38c each of different wavelengths that can be switched in separately using shutters 37a, 37b, 37c to make the same diffraction optical element 16 that will play back efficiently at red, green and blue wavelengths. Dichroic beam splitters 40a, 40b, 40c are used to allow the three required wavelengths to be aligned coaxially with the remainder of exposure system 30′ and individually switched on to make the recording plate 16 prior to being processed into the diffraction optical element 16′.

In one embodiment, the monochromatic light sources or lasers 38a, 38b, and 38c may be manually switched to make the diffraction optical element 16′. In another embodiment, the light sources or lasers 38a, 38b, and 38c may be connected to a controller such as a digital signal processing (DSP) processor (not shown) or a field programmable gate array (not shown) and may be automatically switched on and off sequentially to form the diffraction optical element 16′. Various configurations are possible and within the scope of the present disclosure. A property of the diffraction optical element 16′ is that three diffraction optical elements, all in the same recording plate 16, can share the index of refraction variation available in the recording film that is processed to form the diffraction optical element 16′.

Alternatively, the three diffraction optical elements (one for each wavelength) can be recorded on separate recording plates, which can be bonded together after exposure or laminated to form the diffraction optical element 16′. Various configurations are possible and within the scope of the present disclosure. This latter method has the advantage that the full index of refraction variation in a film layer that is later processed to form the diffraction optical element 16′ can be devoted to a single wavelength which increases the diffraction efficiency of the diffraction optical element 16′. Although the example described applies to three recording wavelengths, the number of wavelengths can be increased to give a larger color gamut. Both the number of colors and the line widths of both the recording and playback wavelengths can be increased and varied to control the color gamut of the final display image. One particular case is the use of light sources or lasers 38a, 38b, 38c for playback illumination, which can achieve very high diffraction efficiency. One method to eliminate possible interference effects with laser illumination is to dither the laser wavelength slightly to blur such interference.

As shown in FIG. 6, the system 30 includes light sources or lasers 38a, 38b, 38c which output beams to a respective shutter 37a, 37b, 37c which then transmits the respective beam having the predetermined wavelength to the respective dichroic beam splitter 40a, 40b, and 40c. The respective beam having the predetermined wavelength is then transmitted to beam splitter 40d and is split into the object beam “A” and the reference beam “B” which ultimately expose the recording plate 16 that later is processed to form the diffraction optical element 16′ with the predetermined wavelength as described above with respect to FIG. 2. In one embodiment, the lasers 38a, 38b, and 38c are a red laser, a green laser and a blue laser, respectively. However various configurations are possible and the system 30 may be formed with other laser arrangements which are discussed within the scope of the present disclosure.

It should be appreciated that the recording film which is processed to form the diffraction optical element 16′ should be sensitive to all of the wavelengths used in construction which may limit the available recording materials. Second, the need for at least three lasers 38a, 38b, and 38c may increase the overall expense for constructing images and may require a larger facility to include ancillary equipment such as water cooling for some lasers. Third, the set-up of the three-wavelength system with coaxial lasers 38a, 38b, and 38c may require additional care and labor to manage and keep the lasers in alignment relative to one another.

Variable Geometry Recording

The present disclosure also relates to a method for simplifying the recording of multiple-wavelength diffraction optical elements by eliminating the need for a minimum of three separate lasers of different wavelengths and a recording material sensitive to all those wavelengths to obtain a well-defined, full-color viewing pupil in the holographic stereo display system under consideration. In particular, the system for constructing the diffraction optical element requires only a single monochromatic light source or laser and a recording material sensitive only to the wavelength of that light source. In this system, the light from three or more diffusers or diffusion screens of different sizes and positions is recorded at the same wavelength as the wavelength of the single monochromatic light source into the same recording plate to form a single diffraction element which contains the diffraction pattern of all three of the diffusion screens.

The position and shape of each of the diffusion screens are calculated, before recording, so that when their images are reconstructed with a different wavelength of light for each, their images, reconstructed from the recorded diffraction optics element, precisely overlay each other. This overlayed reconstructed diffusion image is the viewing pupil in which a display user sees the display image. The three wavelengths that illuminate the diffraction optics element are chosen of such wavelengths and intensity that the viewer sees a full color image of the correct color balance. By projecting two stereo images at different angles onto the diffraction optical element, two side-by-side reconstructions of the overlayed diffusers are created with each showing one of the stereo images. The user sees stereo imagery by placing his eyes so that one eye is in each of the reconstructed overlayed diffusion screen triplet.

Diffraction Element Recording

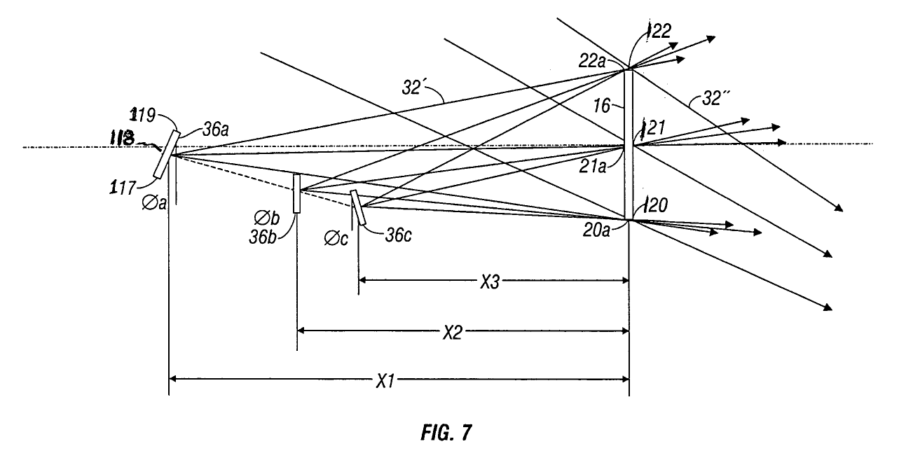

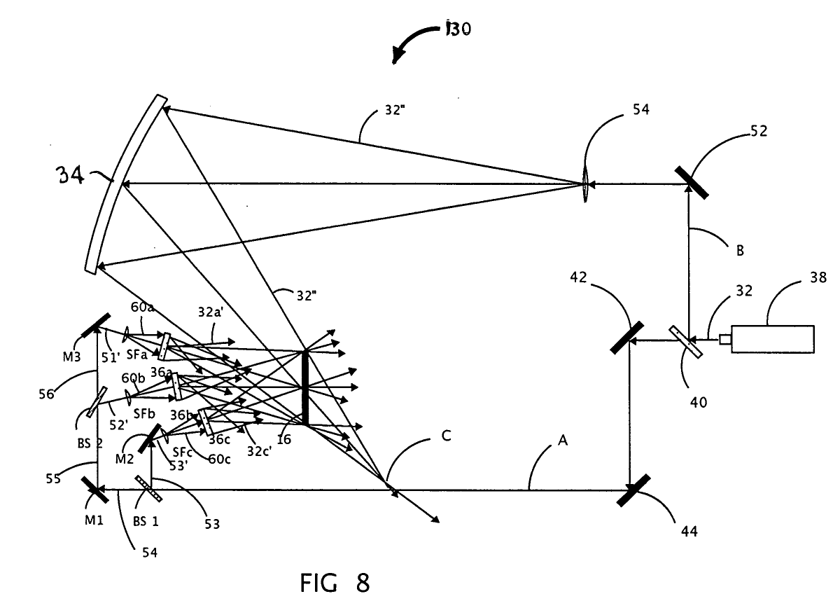

More particularly, referring to FIGS. 7-9, system 130, of FIG. 8, is similar to system 30 of FIG. 2 except that in FIG. 2 the recording plate 16 is exposed with the light 32 from a single diffuser whereas in FIG. 8, the recording plate 16 is exposed with the light, 32a, 32b and 32c from three separate diffusers. In both cases, all diffusers are illuminated with a single wavelength of light. Since only one wavelength is used to expose the recording plate, only a single monochromatic source is needed and the recording material on the plate needs to be sensitive only to that single wavelength.

FIG. 7 shows such a construction geometry in which the same wavelength is used to record each of three diffuser screens. FIG. 7 shows three diffusers; a first diffuser 36a, a second diffuser 36b, and a third diffuser 36c. In this example, the shape and position of diffuser 36b would be chosen as the design viewing area for one eye in the stereo display 10 (see FIG. 1). The diffuse light from 36b would be recorded as a hologram in recording plate 16. The wavelength of the recording beam would typically be green light from a 514.5 nm Argon laser. Next, the light from diffusers 36a and 36c are also recorded into the recording plate 16 using the same laser with the same 514.5 nm green laser light. There are several options for the recording of the three diffusers in a single recording plate: simultaneous recording, sequential or interleaved among them.

As mentioned previously with respect to FIG. 2, after the recording phase, known or other suitable chemical processing methods are employed for any of a variety of holographic recording materials that might be used to process the recording plate 16 into an efficient diffraction optical element 16′.

Diffraction Optics Image Playback or Reconstruction

By playing back the reference beam 32″ of FIG. 7 in the reverse direction as illustrated in FIG. 1 or 4A-4B, the diffuse images of the three diffusers 36a, 36b and 36c are reconstructed. Green playback light reconstructs the diffuser 36b in its position in FIG. 7 which is chosen to be that in which a viewer would place his or her eye to see an image. Thus an observer, during playback, placing his eye in the position formerly occupied by diffuser 36b would see the green portion of a display image in the area of the position X2 that diffuser 36b occupied during the construction process. The position X1 of 36a in FIG. 7 is chosen so that when the reference beam 32″ is played back with red light, the reconstruction of diffuser 36a would not occur in the position X1 shown in FIG. 7, but in the same position X2 and shape of diffuser 36b, thus overlaying the green diffuser image of diffuser 36b with a red image. Similarly, when the reference beam 32″ is played back with blue light, the image of diffuser 36c does not appear in the position X3 shown in FIG. 7, but in the same position as the images of diffusers 36a and 36b. Thus, on playback with multiple colors, an observer would see a three color image red, green and blue image within a pupil matching the shape and position X2 of diffuser 36b in FIG. 7.

Diffuser Shape and Position

In order to create the construction geometry to make the three colors reconstruct the images of the three diffusers in the same place, one must calculate the displacement and shape change caused by the change of illumination wavelength to red and blue for the playback of diffusers 36a and 36c. This may be easily done by using the grating equation to transfer points on the position of diffuser 36b from illumination with the green construction reference wavelength to points with playback in the red for 36a or blue for 36c. This gives the distances X1 and X3 and angles Øa and Øc.

The positions of each diffuser shown in FIG. 7 have been calculated so that when each is illuminated with its own particular calculated wavelength of light, it will be reconstructed by the DOE 16′, not where it was during the recording process, but into the same overlapping area in space where the viewer will place his or her eyes.

Thus, for any desired reconstruction wavelength, a diffuser position can be calculated and recorded on the recording plate during construction to make a DOE which will reconstruct that color into the desired eye position viewing area. By adjusting the diffraction efficiency of each diffuser recording, the color gamut which results from the combined colors can be made optimum.

Stereo Projection

In order to make a stereo display, each eye must see a different image corresponding to the displaced position of view from that eye. This is accomplished in the system described by projecting the two different stereo images with two projectors at angles onto the diffraction optics screen. Each projector creates its own reconstruction of the overlayed red, green and blue viewing area described above. The angular separation of the two projectors separates these two reconstructions into two viewing areas alongside one another. By placing each eye in a one of these two viewing areas, each eye sees the different image from a different projector, thus giving the viewer a stereo three-dimensional view.

As an example, in FIG. 7, the position of the green wavelength diffuser 36b is selected to be at the desired eye position from which the observer will view the image in playback. If a green laser is selected to record the diffraction optical element 16′, then in playback, green light reconstructs a viewing pupil of the same size and shape of diffuser 36b at the position X2 where diffuser 36b was located during the exposure of diffraction element 16′. The positions shape, and angles of diffusers 36a and 36c are chosen so that when they are recorded on recording plate 16 with the same green wavelength as that used to record diffuser 36b, then diffraction optical element 16′ will play back both the red wavelength reconstruction of diffuser 36a and the blue wavelength reconstruction of diffuser 36c in the same position as the green wavelength reconstruction of diffuser 36b. This means that all three colors are overlaid in the same viewing area at distance X2 of diffuser 36b.

A simple method to calculate the positions and angles of diffusers 36a and 36c is to use the grating equation to determine for each of several points such as 117, 118 and 119, what grating spacing is required in diffraction optical element 16′ to place a playback ray onto the corresponding point in diffuse element 36b. If this is done for each of three points 120, 121 and 122 then the playback ray directions from these three points will intersect at a point corresponding to the position of the diffuser position for the color for which the grating was calculated. In this manner, the points 117, 118 and 119 define the position and angle of the “red” diffuser 36a and the same may be done for other wavelengths such as the “blue” of diffuser 36c. It is understood that the terms “red” and “blue” refer only to the playback wavelengths. The recording of the diffusers, 36a and 36c which will create the red and blue pupils is done with the same green wavelength which is used to record diffuser 36b.

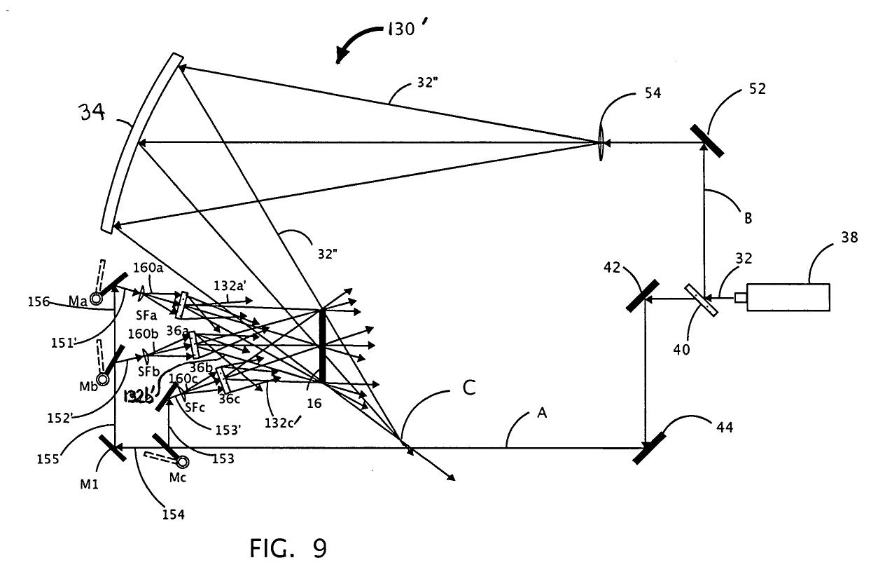

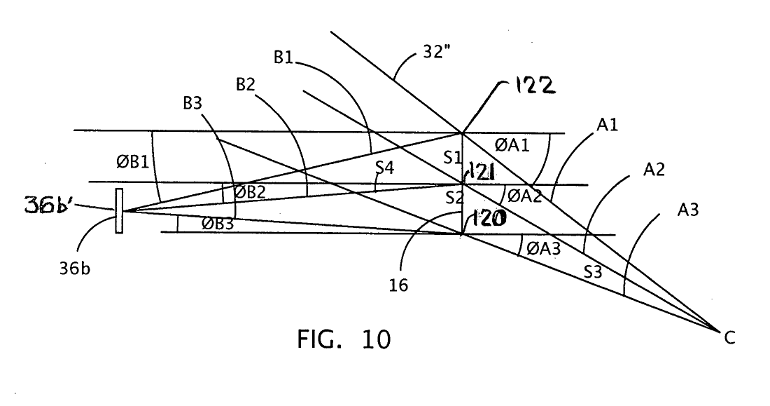

For some display geometries, not that shown in FIG. 7, the light from the diffuser 36b can be partially blocked by diffuser 36c. Further, the light from diffuser 36a can be partially blocked by both diffusers 36b and 36c. This may be circumvented by exposing each diffuser separately as shown in FIG. 9. The exposures may be made either sequentially in the same film or in separate films to be laminated together. This illumination may be either transmitted through the diffusers 36a, 36b or 36c as shown in FIGS. 8 and 9 or reflected from the front surface 36a′, 36b′ or 36c′, respectively, depending on the type of diffuser used.

FIG. 8 shows a system 130 for illuminating the three separate diffusers, 36a, 36b and 36c simultaneously with the single monochromatic light source or laser 38. In the same manner as discussed previously with respect to FIG. 2, the single source beam 32 is split into object beam A and reference beam B. The reference beam B is again reflected off of the reflector 52 and travels through the spatial filter 54 to form the filtered reference beam 32″ after being reflected from concave mirror 34.

Similarly as described with respect to FIG. 2, object beam A is reflected by the first reflector 42 and the second reflector 44. From the second reflector 44, object beam A travels to beamsplitter BS 1 which has a reflectivity of about 33%. That approximately 33% percent of the light of object beam A that is reflected as reflected beam 53 travels to mirror M2 and then travels as reflected beam 53′ through spatial filter SFc where the beam 53′ is expanded as expanded beam 60c to illuminate the diffuser 36c to produce diffuse beam 32c′. The 66% of the light of object beam A which passes through beamsplitter BS1 as beam 54 is reflected by mirror M1 as reflected beam 55 to approximately 50% beamsplitter BS2. Approximately half of this light or about 33% of the original object beam A is reflected by beamsplitter B2 as reflected beam 52′ to spatial filter SFb where the beam 52′ is expanded as expanded beam 60b and then travels on to illuminate diffuser 36b to produce diffuse beam 32b′. The remaining approximately 33% of the light of the original object beam A passes through beamsplitter B2 as beam 56 and then is reflected by mirror M3 as reflected beam 51′. Reflected beam 51′ then travels through spatial filter SFa where the beam 51′ is expanded as expanded beam 60a and then travels to illuminate diffuser 36a to produce diffuse beam 32a′. Thus, the combination of mirrors M1, M2 and M3 and beamsplitters BS1 and BS2 divides the monochromatic source or laser illumination light of object beam A substantially equally between the three diffusers 36a, 36b and 36c. The diffuse beams 32a′, 32b′, 32c′ combined with the reference beam 32″ make the diffraction pattern which is recorded to create the diffraction optics element 16′ in the recording plate 16, as explained above with respect to FIG. 7.

FIG. 9 shows a system 130′ for illuminating the three separate diffusers, 36a, 36b and 36c sequentially. This can be necessary in some cases in which the geometry of the display 10 (see FIG. 1) is such that the calculated position of the diffusers 36a, 36b and 36c is such that one blocks the light emanating from one of the others. (The diffusers 36a, 36b, 36c are not shown in FIG. 9 in positions that would block the light from each one). The solution is to insert only one of the diffusers 36a, 36b or 36c into position at a time. Such a process can be mechanized by setting up a system of shutter mirrors so that the only mechanization required is the movement of the diffusers 36a, 36b and 36c without any need to adjust the optical system 130′ for illumination of different diffusers.

As compared to system 130, system 130′ does not include the beam splitters BS1 and BS2 of FIG. 2 so diffuse beams 132a′, 132b′ and 132c′ are substantially of the same intensity as the original object beam A. To produce only diffuse beam 136c, object beam A travels to flip mirror Mc where, when flip mirror Mc is in its reflecting position to reflect object beam A, object beam A is reflected as reflected beam 153, then reflected beam 153 is reflected by mirror M2 to travel as reflected beam 153′ through spatial filter SFc where the beam 153′ is expanded as beam 160c to illuminate the diffuser 36c to produce diffuse beam 132c′.

To produce only diffuse beam 136b′, with flip mirror Mc in its non-reflecting position and with flip mirror Mb in its reflecting position, object beam A continues as beam 154 to mirror M1 flip mirror Mb where beam 155 is reflected as reflected beam 152′ to spatial filter SFb where the beam 152′ is expanded as expanded beam 160b and then travels on to illuminate diffuser 36b to produce diffuse beam 132b′.

To produce only diffuse beam 136a′, with flip mirrors Mc and Mb in their non-reflecting position and with flip mirror Ma in its reflecting position, object beam A continues as beam 154 past flip mirror Mc to mirror M1 where beam 154 is reflected as reflected beam 155. Reflected beam 155 travels past flip mirror Mb and continues to travel as beam 156 to flip mirror Ma where beam 156 is reflected as reflected beam 151′ to spatial filter SFa where the beam 151′ is expanded as expanded beam 160a and then travels on to illuminate diffuser 36a to produce diffuse beam 132a′.

The diffuse beams 132a′, 132b′ and 132c′ each combined separately with the reference beam 32″ make the diffraction pattern which is recorded to create the diffraction optics element 16′ in the recording plate 16, as explained above with respect to FIG. 7.

For conditions of stability for the holographic exposures, it is extremely desirable that there be no entry of persons during the sequence of exposing the three diffusers 36a, 36b and 36c. The flip mirrors Ma, Mb and Mc can be electrically controlled to flip in and out of the particular light or laser beam. Flip mirrors Ma, Mb and Mc are all shown in the position that they would be in if the corresponding diffusers 36a, 36b and 36c are to be illuminated. The dashed position shown for each flip mirror Ma, Mb or Mc is its position when its corresponding diffuser 36a, 36b or 36c, respectively, is not being illuminated. Thus, if all the flip mirrors Ma, Mb, Mc are in their dashed positions, flipping Mc into the solid black position shown permits illumination of diffuser 36c. If all the flip mirrors are set into their dashed positions, then flipping mirror Mb into its solid black position permits illumination of diffuser 36b. If all the flip mirrors are in their dashed positions, then flipping mirror Ma into its solid black position permits illumination of diffuser 36a.

As an example, consider the illumination of diffuser 36b. All the flip mirrors Ma, Mb, Mc are assumed to be in their dotted position where they do not intercept any laser light. Only flip mirror Mb is in its solid black “on” position. The light beam from the laser passes mirror Mc in its off position and is then is reflected by mirror M1 up to mirror Mb which is in its on position, the light reflects from mirror Mb and then passes through spatial filter SFb to illuminate diffuser 36b. The flip mirrors can be remotely operated by solenoids controlled by a computer. The computer can move the appropriate diffuser into position and allow some minutes for it to stabilize before operating the flip mirror to illuminate said diffuser. As an example, a simple step motor drive system can be applied to pull the unneeded diffusers up out of the way for each exposure.

Playback

Referring to FIGS. 1 and 3A-4B, once the recording plate has been exposed and processed to create the holographic diffraction optical element (DOE) 16′, the DOE 16′ diffracts ordinary non-coherent, non-laser light. Two images can be projected onto the DOE 16′ using two suitable digital projectors 12 and 14 such as are used for slide presentations. The DOE 16′ separates the light from each projector 12, 14 and sends the light for two different stereo images to two separate adjacent areas in space. The user 18 places his or her two eyes 20, 22 into those areas to see a stereo image. Obviously, it is desirable that all the colors in the images should appear in the same image spaces with perfect overlap.

An Example Showing how to Calculate the Shape and Position of Multiple Diffusers that can be Recorded with a Single Wavelength into a Diffraction Optical Element so as to Provide Multicolor Playback

Definition of the Example Configuration.

FIG. 10 shows the nomenclature for the distances and angles involved in the calculations. Referring to FIG. 10, the recording plate or substrate 16 height is the sum of the two distances S1 AND S2. Angles ØA1,ØA2 and ØA3 are the angles of the center and edge rays, A1, A2 and A3 of the reference wavefront 32″. S4 is the distance from the center of the recording plate to the center of diffuser 36b which is the same as B2. The real image of diffuser 36b in playback is the viewing area in which an observer sees the image light diffracted from the diffraction optical element 16′. Angles ØB1,ØB2 and ØB3 are the angles for rays B1, B2 and B3 from the top, center and bottom of the recording plate respectively to the center of the diffuser 36b.

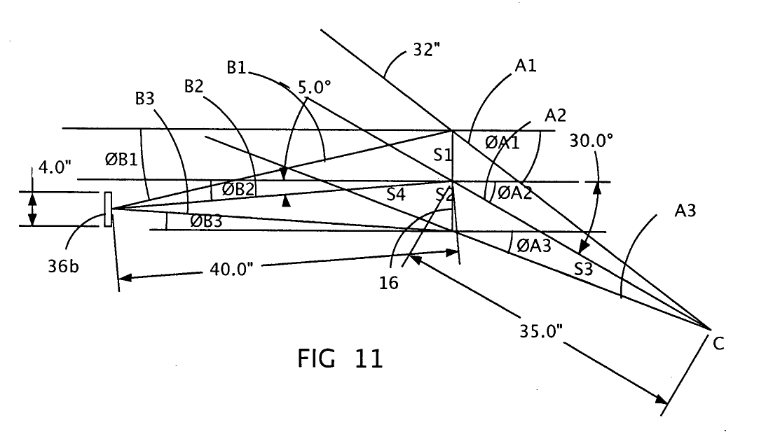

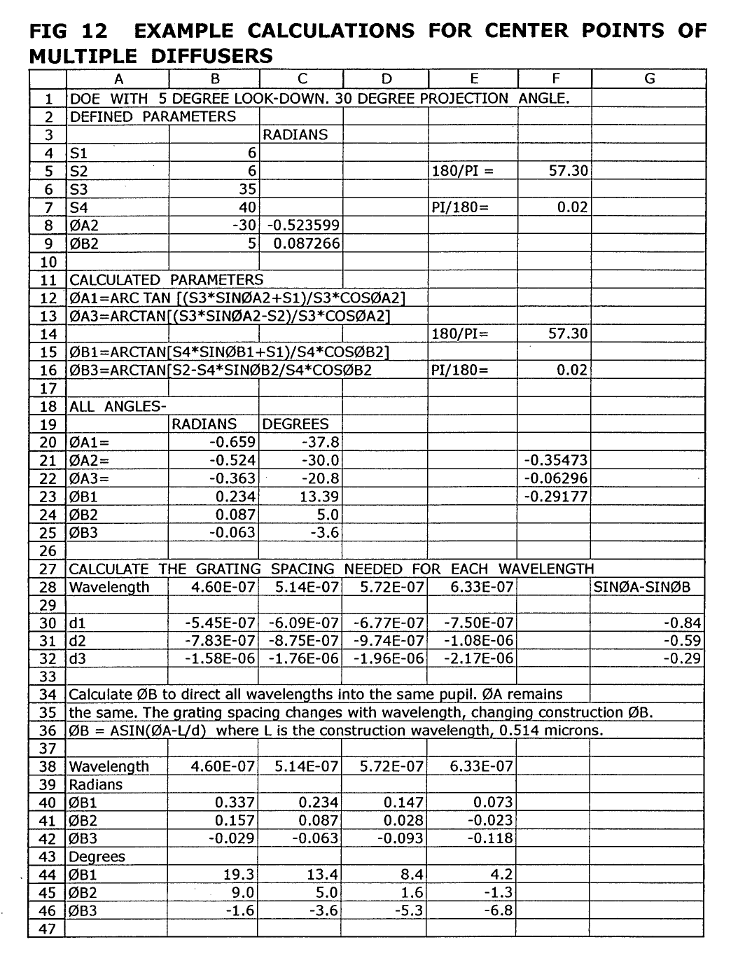

The particular geometry for the example is shown in FIG. 11. S1 and S2 are both 6 inches. S3, the distance from the center of the recording plate to the focus point C is 35 inches. S4, the distance from the center of the recording plate 16 to the center of the diffuser 36b, is 40.0 inches (1.016 meters). The angle of the reference beam ØA2 is −30 degrees. The angle of ray B2, ØB2 is 5 degrees. The equations to calculate the remaining angles of FIG. 11 is shown by the equations of lines 12 through 16 on FIG. 12, that are repeated below.
ØA1=ARCTAN[(S3*SIN ØA2+S1)/S3*COS ØA2]
ØA3=ARCTAN[(S3*SIN ØA2−S2)/S3*COS ØA2]
ØB1=ARCTAN[(S4*SIN ØB1+S1)/S3*COS ØB2]
ØB3=ARCTAN[(S2−S4*SIN ØB2)/S4*COS ØB2]

Using the selected numbers for the size of the recording plate 16, and the other dimensions for this example given above, these equations, the ray angles from the top, center and bottom of the recording plate to the center of the diffuser to point C on the A side and the center of the diffuser on B side as illustrated in lines 20-25 of FIG. 12 as follows:

| | | | |
|---|---|---|---|
| ØA1 = | −0.659 Radians | −37.8 | Degrees |
| ØA2 = | −0.524 Radians | −30 | Degrees |
| ØA3 = | −0.363 Radians | −20.8 | Degrees |
| ØB1 = | 0.234 Radians | 13.4 | Degrees |
| ØB2 = | 0.087 Radians | 5.0 | Degrees |
| ØB3 = | −0.063 Radians | −3.6 | Degrees |

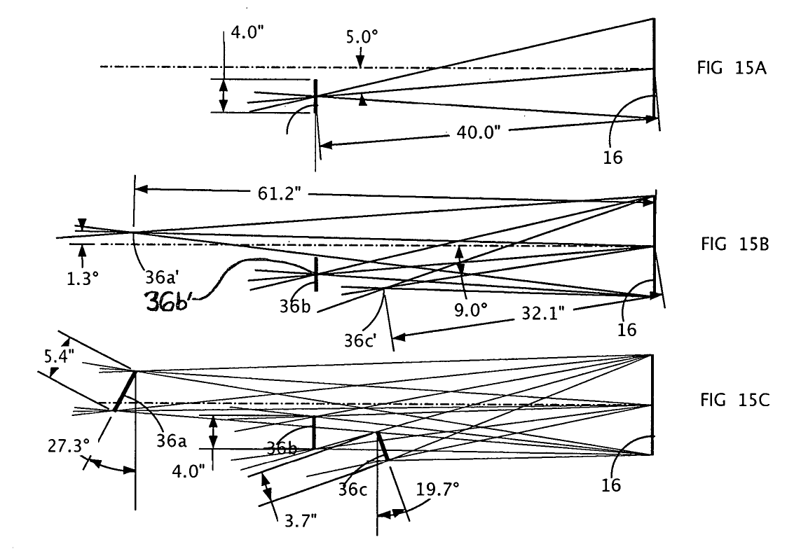

A diagram of the rays, B1, B2 and B3 from the center of the diffuser 36B and the top 122, center 121 and bottom 120 of the recording plate 16 is shown in FIG. 15A.

Method for Calculating the Center Positions of Additional Diffusers Needed for Full Color Diffraction into the Viewing Pupil.

Need for More Diffusers.

If the diffuser 36 is recorded with green light into the recording plate 16 with the reference beam 32, then when an image is projected onto the finished diffraction element, 16′, from point C, effectively reversing the reference beam, then diffraction element 16′ will reconstruct a real image of diffuser 36, sending the light from the image projected on the screen into the position where diffuser 36 was located during the recording process. Thus, an observer placing his eye in this area where the light is diffracted will see the green light from an image projected onto the diffraction element 16′. However, red or blue light will be diffracted to a different area and will not be seen by the observer. It is required that an additional diffuser be recorded into diffraction element 16′ of the form and position that the diffracted light from a projected image of red or blue light will fall into the same viewing area as that in which the green light is diffracted, i.e., the area in which diffuser 36 was located during the green recording process. Separate new diffusers must be recorded for the red and blue wavelengths in the image.

Grating Spacing Calculations

In order to find the shape and position of the required additional diffusers, one can first determine the grating spacings which must be recorded into recording plate 16 to form the diffraction element 16′ which will properly diffract the desired wavelengths into the viewing area defined by the reconstruction of the green diffuser. Then, from these required grating spacings, one can derive the rays needed to form them during the green light recording onto the recording plate 16. The grating equation can be used to determine the grating spacing needed to diffract the same reference beams, but at different wavelengths into the area of the reconstructed green diffuser 36. For this purpose, it is convenient to use the grating equation in the following form in which the grating spacing d in the recorded plate is given by:
d=(SIN ØA−SIN ØB)/L, where:
d=grating spacing
L=wavelength of light
ØA and ØB have the definitions shown in FIG. 10.

For the example, in FIG. 12, (SIN ØA−SIN ØB) is calculated in cells G28 through G32 for the top, center and bottom ray intercepts on the recording plate 16. There are three of these calculations for: angles formed by the angles of rays A1 and B1, A2 and B2 and A3 and B3. These ray definitions are shown in the diagram of FIG. 10. Dividing these numbers SIN ØA−SIN ØB by each wavelength L gives three grating spacings, d1, d2, d3 for each wavelength as shown in FIG. 12 in lines 30, 31 and 32. In a further example, cells B30 through B32 give the required grating spacings d1, d2, d3 for a wavelength of 0.46 microns by dividing cells G30 through G32 for SIN ØA−SIN ØB by the wavelength of 0.46 microns. Reading across, the same calculations are done for wavelengths of 0.514, 0.572 and 0.633 microns. These grating spacings, d1, d2 and d3 are for the top, center and bottom ray diffraction patterns at 122, 121, 120, respectively, made by the combination of the A1 and B1 rays, A2 and B2 rays and A3 and B3 rays respectively.

Given these grating spacings in the diffraction element 16′, the element 16′ will diffract a reference beam such as A2 into the corresponding beam B2 for the four different wavelengths shown in FIG. 12 on line 28. To construct a diffraction element that will display the wavelengths of FIG. 12, the recording plate, 16, must record holograms at each point that have the appropriate grating spacings d1, d2 and d3.

Calculation of Rays to Record the Requisite Grating Spacings in the Recording Plate 16.

The reference ray directions ØA, ØB and ØC are the same for each wavelength that is projected onto the diffraction element 16a′ as tabulated in lines 20,21 and 22 in FIG. 12. The grating spacing is calculated from that required to send the light of each color into the viewing pupil defined by the recording position of diffuser 36 and is tabulated in lines 30, 31 and 32 in FIG. 12. Thus, the only unknowns are the angles of the rays ØA1 and ØA3 to match the grating spacing. To calculate those angles, a convenient form of the grating equation is:
SIN ØA−SIN ØB=L/d

This equation is used to determine the ray angles for the various wavelengths that will create the grating spacings d1, d2, d3 that have been calculated in rows 30-32. The only variables are the new angles ØB1, B2 and Ø B3, for each reconstruction wavelength to record the required grating spacing during recording of the hologram in the original green wavelength.

Writing the grating equation in the form:
SIN ØA−SIN ØB=L/d
with the same definitions as above, one can rearrange the equation to find the required new angle ØB as:
ØB=A SIN(SIN ØA−L/d)

The results of these calculations for four different wavelengths L1, L2, L3 and L4 gives the new angles ØB1′, ØB2′, ØB3′ and ØB4′ in radians in lines 40, 41 and 42 for each wavelength. These angles are converted from radians to degrees and shown in FIG. 12 in lines 44, 45 and 46. A plot of these rays, from the recording plate 16 at the calculated angles will show intersections which are the centers of the required diffusers to reconstruct the diffusion pupil at each wavelength overlaid on the original green pupil 36b. These new pupil centers are shown on FIG. 15A at the intersections of the rays at angles ØB1, ØB2 and 0B3. Thus this method shows how to construct a hologram in the single recording wavelength of 0.514 microns that will play back at the other wavelengths of 0.46, 0.572 and 0.633 microns with all rays B1′, B2′ and B3′ going to the center of diffuser 36b, the desired viewing pupil.

Find Edge Points of the Added Diffusers

The top and bottom 122 and 120, respectively of the diffusion plates 36a, 36b, 36c at the wavelengths of 0.46 and 0.633 microns can be found by carrying out the procedure that used to find the centers of the diffusers as documented in the foregoing text and FIG. 12.

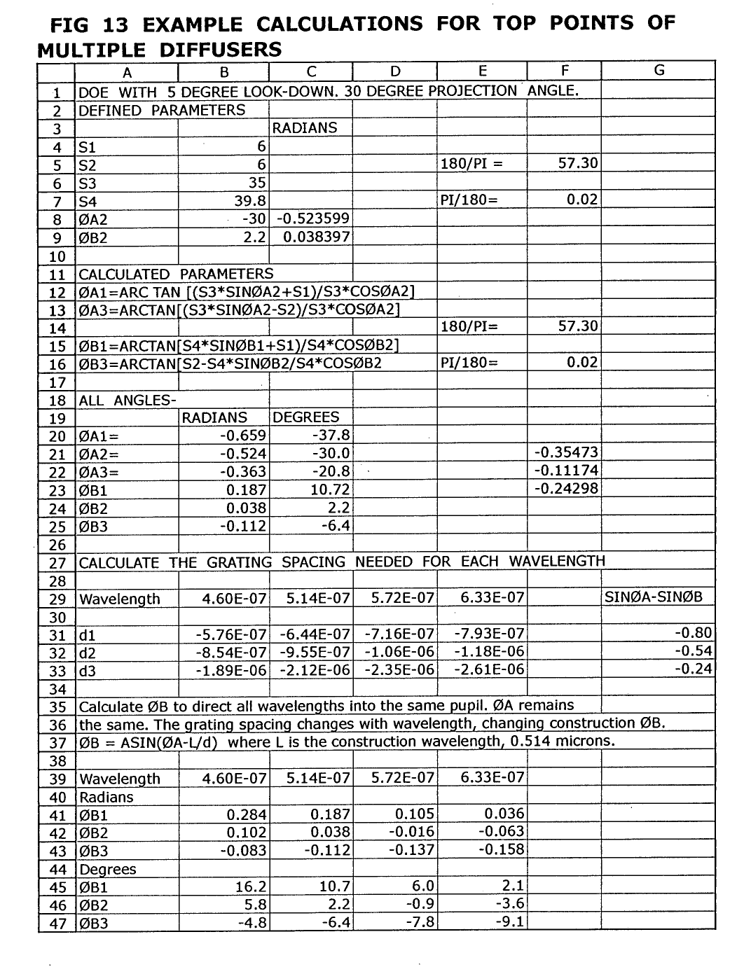

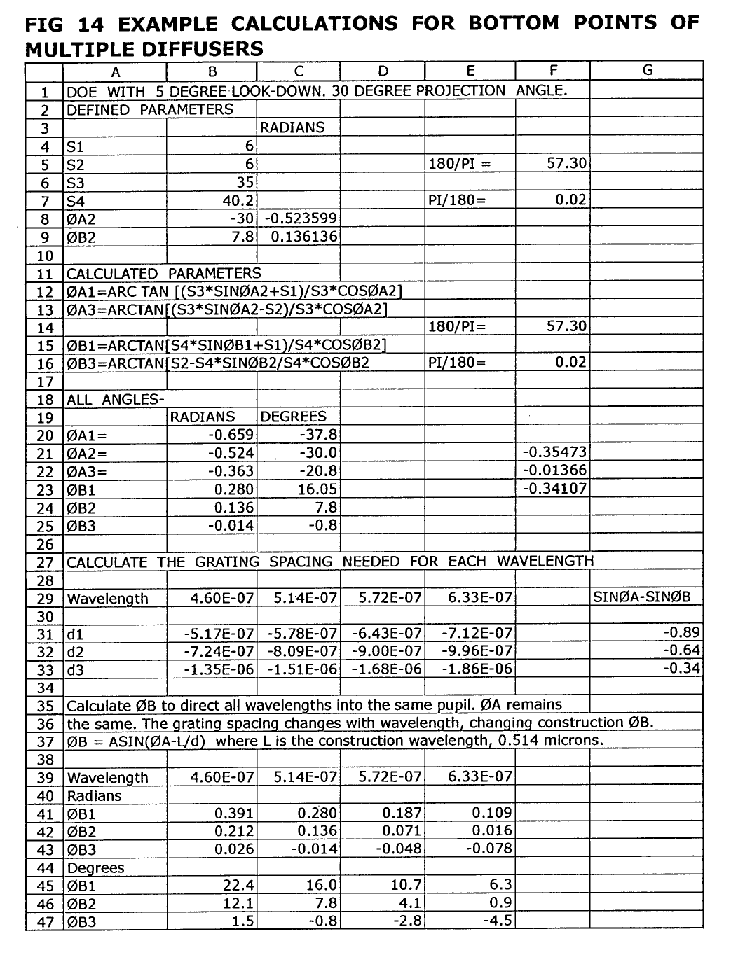

FIG. 13 shows the Excel spreadsheet with the numerical calculations for the points at the top 122 of the diffusers 36a, 36b, 36c. FIG. 14 shows the Excel spreadsheet with the calculations for the bottom 120 of the diffusers 36a, 36b, 36c.

The results of these calculations are plotted in FIG. 15C, which by showing the top and bottom edges define the position of each of the additional diffusers 36a and 36c. To avoid confusion in the plots, only the red, blue and green wavelengths are plotted in FIGS. 15A, 15B and 15C, Although not plotted, the third column (in cells D28 to D46) giving calculations for an orange wavelength of 0.572 microns shows that it is simple to add more than three wavelengths for wider color gamut.

This example of the calculation method dealt with three simple straight line diffusers in edgewise view. The method can, of course be applied to complex shapes in three-dimensional space by repeating the calculations for however many points are required to define the reconstruction wavelength positions to the desired level of accuracy.

Thus, the diffraction optical element so constructed will play back a viewing pupil in which red, green and blue light exactly overlay the defined viewing pupil, although the optical element was exposed with only green light in a recording material that need be sensitive to only green light.

As can be appreciated from the foregoing description, the present disclosure of Light emitting diodes (LEDs) and solid state lasers are increasingly replacing thermal and arc sources as the light sources employed for optical projectors. The specific color diffuser positions enabled by the present disclosure can be matched to these new light sources to provide a wider color gamut as well as a better defined viewing area for better uniformity across a larger stereo viewing area.

From the foregoing and with reference to the various figure drawings, those skilled in the art will appreciate that certain modifications can also be made to the present disclosure without departing from the scope of the same. For example, particular designs can be detailed by using fundamental grating equations or well-known holographic design equations.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as describing exemplary embodiments.

What is claimed is:

1. A system for recording a diffraction optical element providing a stereographic image to an observer, comprising:
a monochromatic light source having a characteristic wavelength, the light source configured to provide a single source beam at the wavelength characteristic of the light source;
a recording plate made from a material sensitive substantially only to the characteristic wavelength of the source beam emitted by the monochromatic light source;
at least first, second and third diffusers each having a characteristic wavelength differing from one another, the at least first, second and third diffusers configured and disposed to output as a diffuse light beam separately first, second and third diffraction patterns, respectively, a first beam split from the single source beam received from the monochromatic light source, the first beam being at the wavelength characteristic of the monochromatic light source; and
at least one mirror configured and disposed to reflect as a converging reference beam a second beam split from the single beam received from the monochromatic light source, the second beam being at the wavelength characteristic of the monochromatic light source,
wherein the recording plate is exposed to the diffuse light beam separately passing through the at least first, second and third diffusers and received from the first beam and wherein the recording plate is exposed to the converging reference beam reflected from the at least one mirror to form thereby the diffraction optical element.

2. A system according to claim 1, wherein the recording plate is exposed to the diffuse light beam output from the at least first, second and third diffuser screens sequentially.

3. A system according to claim 1, wherein the recording plate is exposed to the diffuse light beam output from the at least first, second and third diffuser screens concurrently.

4. A system according to claim 1, wherein the at least first, second and third diffuser screens are each characterized by an image, wherein when the respective images are reconstructed from the diffraction optical element, the reconstructed images substantially overlay one another.

5. A system according to claim 1,
wherein the first optical diffuser is disposed at a first distance from the recording plate,
wherein the second optical diffuser is disposed at a second distance from the recording plate, and
wherein the third optical diffuser is disposed at a third distance from the recording plate.

6. The system according to claim 5, wherein the first distance is greater than the second distance and the second distance is greater than the third distance.

7. A system for viewing a diffraction optical element providing a stereographic image to an observer, comprising:
a diffraction optical element
wherein the diffraction optical element is made by a monochromatic light source having a characteristic wavelength, the light source configured to provide a single source beam at the wavelength characteristic of the light source,
wherein the diffraction optical element is made from a recording plate made from a material sensitive substantially only to the characteristic wavelength of the source beam emitted by the monochromatic light source,
wherein the diffraction optical element is made by at least first, second and third diffusers each having a characteristic wavelength differing from one another, the at least first, second and third diffusers configured and disposed to output as a diffuse light beam separately first, second and third diffraction patterns, respectively, a first beam split from the single source beam received from the monochromatic light source, the first beam being at the wavelength characteristic of the monochromatic light source,
wherein the diffraction optical element is made by at least one mirror configured and disposed to reflect as a converging reference beam a second beam split from the single beam received from the monochromatic light source, the second beam being at the wavelength characteristic of the monochromatic light source,
wherein the recording plate is made by exposure to the diffuse light beam separately passing through the at least first, second and third diffusers and received from the first beam,
wherein the recording plate is made by exposure to the converging reference beam reflected from the at least one mirror, and
wherein the diffraction optical element is a recorded interference pattern between the converging reference beam and the diffuse light beam output from the at least one diffuser to form thereby the diffraction optical element.

8. A system according to claim 7,
wherein the diffraction optical element is disposed between at least first and second optical projectors and an observer, the observer and the diffraction optical element forming generally a forward field of view, and
wherein the at least first and second optical projectors each projects a light beam onto the diffraction optical element from an angle below the forward field of view.

9. A system for recording a diffraction optical element providing a stereographic image to an observer, comprising:
first, second, and third monochromatic light sources each emitting a coherent monochromatic light beam having a wavelength;
a recording plate;
at least one diffuser configured and disposed to output a diffuse light beam from the at least first, second and third monochromatic light sources; and
at least one concave mirror configured and disposed to reflect a converging reference beam from the at least first, second and third monochromatic light sources,
wherein the recording plate is exposed to the diffuse light beam output from the at least one diffuser, and
wherein the recording plate is exposed to the converging reference beam reflected from the at least one concave mirror.

10. The system according to claim 9,
wherein the wavelength of the coherent monochromatic light beam emitted from the first monochromatic light source differs from the wavelength of the coherent monochromatic light beam emitted from the second monochromatic light source and from the wavelength of the coherent monochromatic light beam emitted from the third monochromatic light source, and
wherein the wavelength of the coherent monochromatic light beam emitted from the second monochromatic light source differs from the wavelength of the coherent monochromatic light beam emitted from the third monochromatic light source.

11. The system according to claim 10, further comprising:
a first dichroic beam splitter configured and disposed to receive the coherent monochromatic light beam emitted from the first monochromatic light source;
a second dichroic beam splitter configured and disposed to receive the coherent monochromatic light beam emitted from the second monochromatic light source; and
a third dichroic beam splitter configured and disposed to receive the coherent monochromatic light beam emitted from the third monochromatic light source.

12. The system according to claim 11, further comprising:
a fourth dichroic beam splitter,
wherein the first, second and third dichroic beam splitters are each configured and disposed to allow the coherent monochromatic light beam emitted from the first monochromatic light source and received by the first dichroic beam splitter,
the coherent monochromatic light beam emitted from the second monochromatic light source and received by the second dichroic beam splitter, and
the coherent monochromatic light beam emitted from the third monochromatic light source and received by the third dichroic beam splitter to be each aligned coaxially as a coherent chromatic light beam
wherein the fourth dichroic beam splitter is disposed with respect to the first, second and third dichroic beam splitters to split the respective coaxially aligned coherent chromatic light beams split by the first, second and third dichroic beam splitters into at least first and second chromatic light beams,
wherein the first chromatic light beam is the diffuse light beam output from the at least one diffuser, and
wherein the second chromatic light beam is the converging reference beam reflected from the at least one concave mirror.

13. The system according to claim 12, further comprising:
a first shutter disposed between the first monochromatic light source and the first dichroic beam splitter to selectively enable transmission and termination of the first monochromatic light beam from the first monochromatic light source;
a second shutter disposed between the second monochromatic light source and the second dichroic beam splitter to selectively enable transmission and termination of the second monochromatic light beam from the second monochromatic light source; and
a third shutter disposed between the third monochromatic light source and the third dichroic beam splitter to selectively enable transmission and termination of the third monochromatic light beam from the third monochromatic light source.

14. The system according to claim 13, wherein the first, second and third shutters are individually operated to selectively transmit and terminate the respective first, second and third monochromatic light beams to enable exposure of the recording plate.

15. A method of recording a holographic optical element for forming a multicolor image from a projection of said image onto the holographic element.

16. The method of claim 15 in which the recording beams are all at a single wavelength.

17. The method of claim 16 in which the multicolor playback illumination may consist of two or more single wavelengths of light.

18. The method of claim 15 in which the pupils from which the multicolor image may be viewed are substantially congruent in space.

19. The method of claim 18 in which the diffraction efficiency of the congruent pupils may be adjusted to achieve a predetermined image color temperature. All colors are simulated in the eye of the viewer by an appropriate combination of the colors reproduced by each recorded diffuser, illumination combination.

20. The method of claim 15 in which the holographic optical element may be either of the transmission or reflection type.

21. The method of claim 15 in which the holographic optical element is formed by recording a spherical wavefront and a diffuse wavefront emanating from the area or pupil from which the image is to be viewed.

22. The method of claim 21 in which the recording consists of a series of diffusers, each reproduces one of the wavelengths of the color corresponding to one of the colors in the image to be viewed. The shape and position of these additional diffusers are calculated by the grating or Bragg equations so that when illuminated with their corresponding wavelengths of light, they appear congruent with each other to form effectively a single viewing pupil or area for the user. These diffusers, although they play back different wavelengths in the image to be viewed are recorded with the single wavelength in the formation of the diffraction optical element as described in claim 2.

23. The method of claim 22 in which the recording of the separate diffusers is done concurrently by a single illumination beam onto a single recording substrate.

24. The method of claim 22 in which each separate diffuser is recorded individually on separate recording substrates which are then subsequently placed or bonded together to form effectively a single diffraction element.

25. The method of claim 22 in which each separate diffuser is recorded consecutively in a single recording plate.

26. The method of claim 25 in which the recording of each diffuser is not carried to completion in a single step, but the total recording consists of a series of partial recordings of each diffuser interleaved in time so that the optical element is formed gradually with each diffuser recording spread over the total recording time, thus ensuring that each sees the same recording material characteristics ensuring uniformity and consistency for each diffuser relative to the other.

27. The method of claim 15 in which the diffraction optical element may be used to provide an auto-stereoscopic viewing system by projecting stereo images from two different angles to provide multicolor viewing pupils corresponding to each eye.

28. The method of claim 27 in which the viewing system may include a reflection or transmission optical element.

29. The method of claim 15 in which the image may be projected by a thermal, arc, laser or any other light source.
